(19) United States
(12) Patent Application Publication
(10) Pub. No.: US 2021/0303258 A1
(43) Pub. Date: Sep. 30, 2021

(54) INFORMATION PROCESSING DEVICE, INFORMATION PROCESSING METHOD, AND RECORDING MEDIUM

(71) Applicant: SONY CORPORATION, TOKYO (JP)

(72) Inventor: TOMOHISA TANAKA, TOKYO (JP)

(21) Appl. No.: 17/250,728

(22) PCT Filed: Aug. 30, 2019
(86) PCT No.: PCT/JP2019/034309

§ 371 Date: Feb. 25, 2021

(30) Foreign Application Priority Data
Sep. 6, 2018 (JP) 2018-167323

(51) Int. Cl. G06F 3/16; G06T 19/00; G06F 3/01; G06F 3/0346

(52) U.S. Cl. CPC G06F 3/165; G06T 19/006; H04S 7/303; G06F 3/0346; G06F 3/167; G06F 3/011

(57) ABSTRACT

To provide an information processing device, an information processing method, and a recording medium that enable improving spatial recognition by the user in a technology using an optical system. An information processing device (100) according to the present disclosure includes an acquisition unit (32) configured to acquire a change in a distance between a first object operated by a user on a real space and a second object displayed on a display unit, and an output control unit (33) configured to perform first control such that vibration output from a vibration output device is continuously changed on the basis the acquired change in the distance.

### FIELD

The present disclosure relates to an information processing device, an information processing method, and a recording medium. Specifically, the present disclosure relates to processing of controlling an output signal in accordance with a user's motion.

### BACKGROUND

In technologies such as augmented reality (AR), mixed reality (MR), and virtual reality (VR), there has been used a technique that enables device operation with image processing of displaying virtual objects and sensing-based recognition.

For example, in object composition, there has been known a technique that acquisition of the depth information of a subject included in a captured image and performance of effect processing enable easily telling whether or not the subject is present within an appropriate range. Furthermore, there has been known a technique enabling highly accurate recognition of the hand of a user wearing a head mounted display (HMD) or the like.

### CITATION LIST

### Patent Literature

Patent Literature 1: JP 2013-118468 A

Patent Literature 2: WO 2017/104272 A

### SUMMARY

### Technical Problem

Here, there is room for improvement in the above conventional techniques. For example, in AR and MR technologies, a user may be required to perform some kind of interaction such as manually touching a virtual object superimposed on the real space.

However, due to the characteristics of human vision, it is difficult for the user to recognize the sense of distance to the virtual object displayed at a short distance. Thus, even if the user tries to touch manually the virtual object, his/her hand has not reached it or conversely his/her hand has put over it. That is, in the conventional techniques, it has been difficult to improve recognition, by the user, to such a virtual object superimposed on the real space.

Therefore, the present disclosure proposes an information processing device, an information processing method, and a recording medium that enable improving spatial recognition by the user in a technology using an optical system.

### Solution to Problem

To solve the above-described problem, an information processing device according to one aspect of the present disclosure, comprises: an acquisition unit configured to acquire a change in a distance between a first object operated by a user on a real space and a second object displayed on a display unit; and an output control unit configured to perform first control such that vibration output from a vibration output device is continuously changed based on the acquired change in the distance.

### Advantageous Effects of Invention

An information processing device, an information processing method, and a recording medium according to the present disclosure enable improving the spatial recognition by the user in a technology using an optical system. Note that the effects described herein are not necessarily limited and thus may be any effect described in the present disclosure.

### BRIEF DESCRIPTION OF DRAWINGS

FIG. 1 illustrates the overview of information processing according to a first embodiment of the present disclosure.

FIG. 2 illustrates the exterior appearance of an information processing device according to the first embodiment of the present disclosure.

FIG. 3 is a diagram illustrating an exemplary configuration of the information processing device according to the first embodiment of the present disclosure.

FIG. 4 illustrates an example of output definition data according to the first embodiment of the present disclosure.

FIG. 5 is an explanatory illustration (1) of the information processing according to the first embodiment of the present disclosure.

FIG. 6 is an explanatory illustration (2) of the information processing according to the first embodiment of the present disclosure.

FIG. 7 is an explanatory illustration (3) of the information processing according to the first embodiment of the present disclosure.

FIG. 8 is a flowchart (1) illustrating the flow of the processing according to the first embodiment of the present disclosure.

FIG. 9 is a flowchart (2) illustrating the flow of the processing according to the first embodiment of the present disclosure.

FIG. 10 is a flowchart (3) illustrating the flow of the processing according to the first embodiment of the present disclosure.

FIG. 11 is an explanatory illustration (1) of information processing according to a second embodiment of the present disclosure.

FIG. 12 is a diagram illustrating an exemplary configuration of an information processing device according to the second embodiment of the present disclosure.

FIG. 13 illustrates an example of output definition data according to the second embodiment of the present disclosure.

FIG. 14 is an explanatory illustration (2) of the information processing according to the second embodiment of the present disclosure.

FIG. 15 is an explanatory illustration (3) of the information processing according to the second embodiment of the present disclosure.

FIG. 16 is a flowchart (1) illustrating the flow of the processing according to the second embodiment of the present disclosure.

FIG. 17 is a flowchart (2) illustrating the flow of the processing according to the second embodiment of the present disclosure.

FIG. 18 is a flowchart (3) illustrating the flow of the processing according to the second embodiment of the present disclosure.

FIG. 19 is a diagram illustrating an exemplary configuration of an information processing system according to a third embodiment of the present disclosure.

FIG. 20 is a diagram illustrating an exemplary configuration of an information processing system according to a fourth embodiment of the present disclosure.

FIG. 21 is an explanatory illustration of information processing according to the fourth embodiment of the present disclosure.

FIG. 22 is a hardware configuration diagram of an example of a computer that achieves functions of the information processing device.

### DESCRIPTION OF EMBODIMENTS

Hereinafter, embodiments of the present disclosure will be described in detail with reference to the drawings. Note that in each of the following embodiments, the same parts are denoted with the same reference signs, and thus duplicate description thereof will be omitted.

### 1. First Embodiment

### 1-1. Overview of Information Processing According to First Embodiment

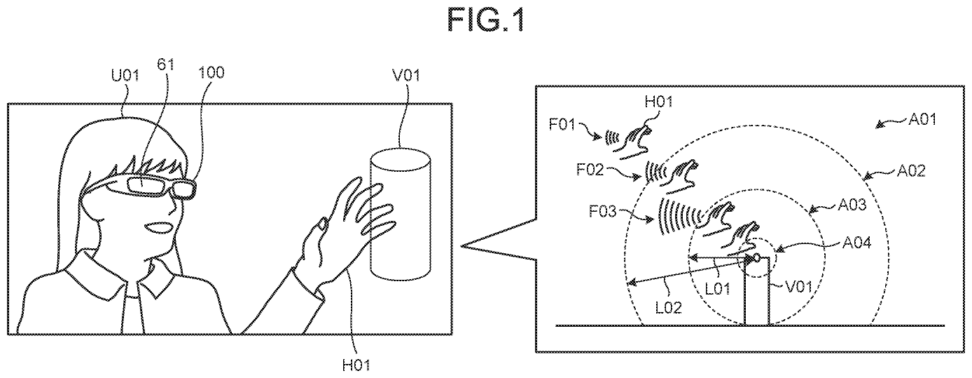

FIG. 1 illustrates the overview of information processing according to a first embodiment of the present disclosure. The information processing according to the first embodiment of the present disclosure is performed by an information processing device 100 illustrated in FIG. 1.

The information processing device 100 is an information processing terminal for achieving so-called AR technology and the like. In the first embodiment, the information processing device 100 is a wearable computer to be used while being worn on the head of the user U01, and specifically, is an AR glass.

The information processing device 100 includes a display unit 61 which is a transparent display. For example, the information processing device 100 superimposes an object on the real space and displays the superimposed object represented by computer graphics (CG) or the like on the display unit 61. In the example of FIG. 1, the information processing device 100 displays a virtual object V01 as the superimposed object. Furthermore, the information processing device 100 has a configuration for outputting a predetermined output signal. For example, the information processing device 100 includes a control unit that outputs a sound signal to a speaker included in this information processing device 100, an earphone worn by the user U01, or the like. Note that in the example of FIG. 1, the illustration of the speaker, earphone, and the like is omitted. In addition, the sound signal in the present disclosure includes not only human and animal voices but also various sounds such as effect sound and background music (BGM).

With the AR technology, the user U01 can perform an interaction such as touching the virtual object V01 or manually picking up the virtual object V01, with any input means on the real space. The any input means is an object that the user operates and is an object recognizable on a space by the information processing device 100. For example, such any input means is part of the user's body such as a hand or foot, or a controller being held in a hand of the user. In the first embodiment, the user U01 uses his/her hand H01 as an input means. In this case, touching the virtual object V01 by the hand H01 means that, for example, the hand H01 is present in a predetermined coordinate space where the information processing device 100 recognizes that the user U01 has touched the virtual object V01.

The user U01 can visually recognize the real space that is visually recognized transparently through the display unit 61 and the virtual object V01 superimposed on the real space. Then, the user U01 performs an interaction of touching the virtual object V01 with the hand H01.

However, due to the characteristics of human vision, it is difficult for the user U01 to recognize the sense of distance to the virtual object V01 displayed at a short distance (e.g., within a range of about 50 cm from the user's point of view). Due to the structure of the human eyes, this may occur from inconsistency between the sense of distance presented by the binocular parallax (stereoscopic vision) of the virtual object V01 and adjustment in convergence, resulting from fixing of the optical focal length of the display unit 61 and the angle of convergence of the left and right eyes. As a result, it is likely that the hand H01 has not reached the virtual object V01 even if the user U01 thinks he/she has touched it, or conversely, the hand H01 has put over the virtual object V01. In addition, in a case where the AR device has not recognized an interaction with the virtual object V01, it is difficult for the user U01 to determine where to move the hand H01 in order to recognize the interaction, which results in difficulty in correcting the position.

Therefore, the information processing device 100 according to the present disclosure performs the information processing described below, in order to improve the recognition in the technology such as AR using an optical system. Specifically, the information processing device 100 acquires a change in the distance between a first object (hand H01 in the example of FIG. 1) operated by the user U01 on the real space and a second object (virtual object V01 in the example of FIG. 1) displayed on the display unit 61. Then, on the basis of the acquired change in the distance, the information processing device 100 performs control such that the mode of an output signal is changed continuously (hereinafter, may be referred to as “first control”). More specifically, the information processing device 100 continuously changes vibration output (e.g., sound output) from a vibration output device (e.g., speaker) in accordance with the change in the distance between the hand H01 and the virtual object V01. This allows the user U01 to correct the position where the hand H01 is held out in response to the sound, which facilitates determination whether the position of the virtual object V01 is still far from the hand H01 or near the hand H01. That is, the information processing according to the present disclosure enables improving the spatial recognition by the user U01 in the AR technology and the like. Note that as the details will be described later, the vibration output from the vibration output device includes not only output with sound but also output with vibration. Hereinafter, the information processing according to the present disclosure will be described along the flow with reference to FIG. 1.

In the example illustrated in FIG. 1, the user U01 performs an interaction of touching, with the hand H01, the virtual object V01 superimposed on the real space. At this time, the information processing device 100 acquires the spatial position of the hand H01 raised by the user U01. As the details will be described later, with a sensor such as a recognition camera that covers a direction of the line-of-sight of the user U01, the information processing device 100 recognizes the hand H01 present on the real space that the user U01 virtually recognizes transparently through the display unit 61, and acquires the position of the hand H01. In addition, the information processing device 100 recognizes the real space displayed in the display unit 61 as a coordinate space and acquires the position of the virtual object V01 superimposed on the real space.

Furthermore, the information processing device 100 acquires the distance between the hand H01 and the virtual object V01 while the user U01 is extending the hand H01 in the direction of the virtual object V01. Then, the information processing device 100 controls output of a sound signal in accordance with the distance between the hand H01 and the virtual object V01.

In the example of FIG. 1, the information processing device 100 continuously outputs a sound signal such as effect sound repeated at a constant cycle. For example, the information processing device 100 classifies areas into predetermined sections in accordance with the distance between the hand H01 and the virtual object V01, and continuously outputs a sound signal in modes one-to-one different for the classified areas. Note that the information processing device 100 may perform control, with a so-called stereophonic technology, such that the user U01 perceives that sound is being output from the direction of the hand H01.

As illustrated in FIG. 1, the information processing device 100 outputs sound F01 in an area A01 where the distance between the hand H01 and the virtual object V01 is, for example, a distance L02 or more (e.g., 50 cm or more). Furthermore, the information processing device 100 outputs sound F02 in an area A02 where the distance between the hand H01 and the virtual object V01 is a distance L01 or more and below the distance L02 (e.g., 20 cm or more and below 50 cm). Still furthermore, the information processing device 100 outputs sound F02 in an area A03 where the distance between the hand H01 and the virtual object V01 is below the distance L01 (e.g., below 20 cm).

For example, the information processing device 100 performs control such that the mode of sound output continuously changes in the change from the sound F01 to the sound F02 and the change from the sound F02 to sound F03. Specifically, the information processing device 100 performs control such that the volume of the sound F02 is higher than that of the sound F01. Alternatively, the information processing device 100 may perform control such that the cycle of the sound F02 is shorter than that of the sound F01 (i.e., the cycle of repeating reproduction of the effect sound is shorter). Alternatively, the information processing device 100 may perform control such that the frequency of the sound F02 is higher (or lower) than that of the sound F01.

As an example, the information processing device 100 outputs effect sound at the cycle of 0.5 Hz in a case where the hand H01 is present in the area A01. Furthermore, in a case where the hand H01 is present in the area A02, the information processing device 100 reproduces effect sound at the volume of additional 20% higher than the volume output in the area A01, with a tone higher than the sound output in the area A01, and at the cycle of 1 Hz. Still furthermore, in a case where the hand H01 is present in the area A03, the information processing device 100 reproduces effect sound at the volume of additional 20% higher than the volume output in the area A02, with a tone higher than the sound output in the area A02, and at the cycle of 2 Hz.

In such a manner, the information processing device 100 outputs sound which mode changes continuously in accordance with the distance between the hand H01 and the virtual object V01. That is, the information processing device 100 provides the user U01 with acoustic feedback in response to the motion of the hand H01 (hereinafter, referred to as “acoustic feedback”). This allows the user U01 to perceive continuous change such as the volume becoming higher or the cycle of sound repetition becoming increasing, as the hand H01 approaches the virtual object V01. That is, the reception of the acoustic feedback allows the user U01 to recognize accurately whether the hand H01 is approaching or moving away from the virtual object V01.

Then, when the distance between the hand H01 and the virtual object V01 falls below 0, that is, the hand H01 is present in an area A04 recognized as “the hand H01 having touched the virtual object V01”, the information processing device 100 may output sound at a higher volume, a higher frequency, or a larger cycle than that of the sound output in the area A03.

Note that in the case where the hand H01 is present in the area A04, the information processing device 100 may temporarily stop the continuous change in the output mode and may output another effect sound indicating that the virtual object V01 has been touched. This allows the user U01 to accurately recognize that the hand H01 has reached the virtual object V01. That is, in a case where the hand has reached the area A04 from the area A03, the information processing device 100 may maintain the continuous change in the sound, or may temporarily stop the continuous change in the sound.

In such a manner, the information processing device 100 according to the first embodiment acquires a change in the distance between the hand H01 operated by the user U01 on the real space and the virtual object V01 displayed on the display unit 61. Furthermore, on the basis of the acquired change in the distance, the information processing device 100 performs control such that the mode of a sound signal is changed continuously.

That is, the information processing device 100 outputs the sound which mode changes continuously in accordance with the distance, which enables the user U01 to recognize the distance to the virtual object V01 not only visually but also auditorily. As a result, the information processing device 100 according to the first embodiment can improve the recognition, by the user U01, to the virtual object V01 superimposed on the real space, which is difficult in only visual recognition. Furthermore, the information processing of the present disclosure allows the user U01 to perform an interaction without relying only the vision, thereby enabling reduction of eye strain and the like that may occur due to the above inconsistency between the convergence and the adjustment. That is, the information processing device 100 can also improve usability in a technology using an optical system such as AR.

Hereinafter, the configuration and the like of the information processing device 100 that realizes the above information processing will be described in detail with reference to the drawings.

### 1-2. Exterior Appearance of Information Processing Device According to First Embodiment

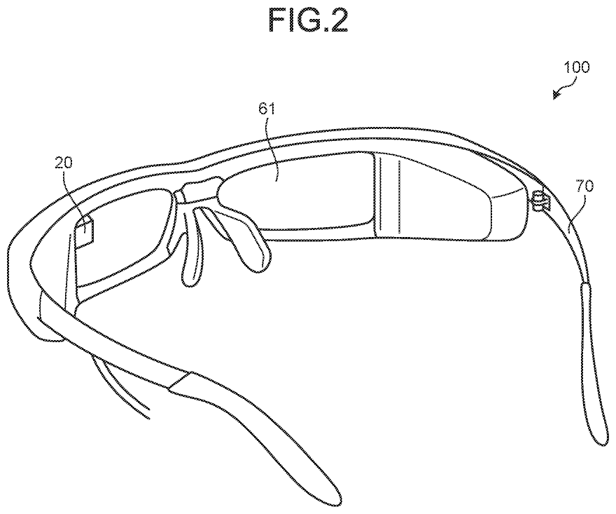

First, the exterior appearance of the information processing device 100 will be described with reference to FIG. 2. FIG. 2 illustrates the exterior appearance of the information processing device 100 according to the first embodiment of the present disclosure. As illustrated in FIG. 2, the information processing device 100 includes a sensor 20, the display unit 61, and a holding part 70.

The holding part 70 has a configuration corresponding to an eyeglass frame. Furthermore, the display unit 61 has a configuration corresponding to eyeglass lenses. The holding part 70 holds the display unit 61 such that the display unit 61 is in front of the user's eyes in a case where the information processing device 100 is worn on the user.

The sensor 20 is a sensor that senses various types of environmental information. For example, the sensor 20 has a function as a recognition camera for recognizing the space in front of the user's eyes. In the example of FIG. 2, only one sensor 20 is illustrated; another sensor 20, however, may be further provided at the display unit 61 for a so-called stereo camera.

The sensor 20 is held by the holding part 70 so as to be faced in a direction where the user's head is oriented (i.e., the front of the user). With such an arrangement, the sensor 20 recognizes a subject in front of the information processing device 100 (i.e., a real object on the real space). Furthermore, in addition to acquisition of images of the subject in front of the user, the sensor 20 can calculate a distance from the information processing device 100 (in other words, the position of the user's point of view) to the subject on the basis of the parallax between the images captured by the stereo camera.

Note that if the distance between the information processing device 100 and the subject is measurable, the configuration of the information processing device 100 and the measuring approach are not particularly limited. As a specific example, the distance between the information processing device 100 and the subject may be measured with a technique such as multi-camera stereo, moving parallax, time of flight (TOF), or structured light. TOF is a technique in which light such as infrared rays is posted onto a subject and the time until the posted light is reflected on the subject and returned from the subject is measured for each pixel, thereby acquiring an image including the distance (depth) to the subject on the basis of the measurement results (so-called distance image). In addition, structured light is a technique in which a pattern is projected onto a subject by using light such as infrared rays and the projected subject is captured, thereby acquiring a distance image including the distance (depth) to the subject on the basis of a change in the pattern obtained from the capturing results. Furthermore, moving parallax is a technique of measuring a distance to a subject on the basis of the parallax even with a so-called monocular camera. Specifically, the camera is moved to capture images of the subject from different points of view, and the distance to the subject is measured on the basis of the parallax between the captured images. Note that at this time, recognition of the movement distance and movement direction of the camera with various types of sensors enables more accurately measuring the distance to the subject. Note that the form of the sensor 20 (e.g., monocular camera and stereo camera) may be changed appropriately in accordance with a distance measurement approach.

Furthermore, the sensor 20 may sense not only information regarding the front of the user but also information regarding the user himself/herself. For example, the sensor 20 is held by the holding part 70 such that the user's eyeballs are located within the capturing range in a case where the information processing device 100 is worn on the user's head. Then, the sensor 20 recognizes the direction in which the line-of-sight of the right eye is directed, on the basis of the positional relationship between the captured image of the user's right eyeball of and the right eye. Similarly, the sensor 20 recognizes the direction in which the line-of-sight of the left eye is directed, on the basis of the positional relationship between the captured image of the user's left eyeball and the left eye.

In addition to the function as a recognition camera, the sensor 20 may have a function of sensing various types of information related to a user's motion such as the orientation, inclination, motion, and movement velocity of the user's body. Specifically, as information related to the user's motion, the sensor 20 senses information related to the user's head and posture, motion of the user's head and body (acceleration and angular velocity), direction of the field of view, movement velocity of the point of view, and the like. For example, the sensor 20 functions as various types of motion sensors such as a three-axis accelerometer, a gyro sensor, and a velocity sensor, and senses information related to the user's motion. More specifically, as the motion of the user's head, the sensor 20 detects the respective components in the yaw direction, the pitch direction, and the roll direction and senses a change in at least any of the position and posture of the user's head. Note that the sensor 20 is not necessarily provided at the information processing device 100, and thus may be, for example, an external sensor connected to the information processing device 100 wiredly or wirelessly.

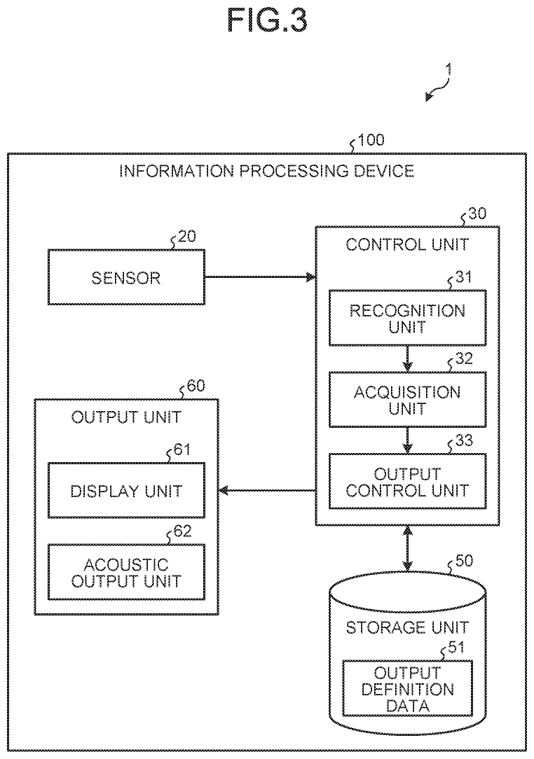

Furthermore, although not illustrated in FIG. 2, the information processing device 100 may include an operation unit that receives input from the user. For example, the operation unit includes input devices such as a touch panel and buttons. For example, the operation unit may be held at a position corresponding to an eyeglass temple. Furthermore, the information processing device 100 may be provided with a vibration output device (e.g., speaker) that outputs a signal such as sound, at the outer face of the information processing device 100. Note that the vibration output device according to the present disclosure may be an output unit built in the information processing device 100 (e.g., built-in speaker). Furthermore, the information processing device 100 incorporates, for example, a control unit 30 (see FIG. 3) that performs the information processing according to the present disclosure.

With such an arrangement as above, the information processing device 100 according to the present embodiment recognizes a change in the position and posture of the user himself/herself on the real space, in response to the motion of the user's head. In addition, the information processing device 100 uses the so-called AR technology on the basis of the recognized information and displays a content on the display unit 61 such that a virtual content (i.e., virtual object) is superimposed on the real object located on the real space.

At this time, the information processing device 100 may estimate the position and posture of this information processing device 100 on the real space on the basis of, for example, a so-called simultaneous localization and mapping (SLAM) technique, and may use such an estimation result for processing of displaying the virtual object.

SLAM is a technique that parallelly performs self-position estimation and environment map creation, with an image-capturing unit such as a camera, and various types of sensors and encoders. As a more specific example, in SLAM (particularly Visual SLAM), the three-dimensional shape of a captured scene (or subject) is sequentially restored on the basis of a captured moving image. Then, the restoration result of the captured scene is associated with the detection result of the position and posture of the image-capturing unit, so that the map of the ambient environment is created and the position and posture of the image-capturing unit in the environment (sensor 20 in the example of FIG. 2, i.e., information processing device 100) are estimated. Note that as above, the position and posture of the information processing device 100 can be estimated as information obtained by detection of various types of information using various types of functions of the sensors such as the accelerometer and the angular velocimeter sensor included in the sensor 20, and indicating a relative change on the basis of the detection results. Note that if the position and posture of the information processing device 100 can be estimated, the approach is not necessarily limited to the technique based on the sensing results of the various types of sensors such as the accelerometer and the angular velocimeter.

Furthermore, examples of the head-mounted display device (HMD) applicable as the information processing device 100 include a see-through HMD, a video see-through HMD, and a retinal projection HMD.

The see-through HMD holds, in front of the user's eyes, a virtual image optical system including, for example, a transparent light guide unit including a half mirror and a transparent light guide plate, and displays an image inside the virtual image optical system. Thus, the outside scenery can come within the field of view of the user wearing the see-through HMD even while the user is viewing the image displayed inside the virtual image optical system. With such an arrangement, for example, on the basis of the AR technology, the see-through HMD can superimpose the image of a virtual object on the optical image of a real object on the real space in accordance with the recognition result of at least any of the position and posture of the see-through HMD. Note that as a specific example of the see-through HMD, there is a so-called eyeglass-type wearable device including a portion corresponding to an eyeglass lens as a virtual image optical system. For example, the information processing device 100 illustrated in FIG. 2 corresponds to an example of the see-through HMD.

In addition, in a case where the video see-through HMD is worn on the user's head or face, it is worn while covering the user's eyes, and a display unit such as a display is held in front of the user's eyes. Furthermore, the video see-through HMD includes an image-capturing unit for capturing an image of the surrounding scenery, and causes the display unit to display an image of the scenery in front of the user captured by the image-capturing unit. With such an arrangement, it is difficult that an outside scenery directly comes within the field of view of the user wearing the video see-through HMD; the user, however, can confirm the outside scenery with the image displayed on the display unit. Furthermore, for example, on the basis of the AR technology, the video see-through HMD may superimpose a virtual object on an image of the outside scenery in accordance with the recognition result of at least any of the position and posture of the video see-through HMD.

In the case of the retinal projection HMD, a projection unit is held in front of the user's eye, and an image is projected from the projection unit toward the user's eye such that an image is superimposed on the outside scenery. Specifically, in the retinal projection HMD, an image is directly projected from the projection unit onto the retina of the user's eye and the image is formed on the retina. With such an arrangement, even a user with myopia or hyperopia can view a clearer picture. Furthermore, the outside scenery can come within the field of view of the user wearing the retinal projection HMD while the user is viewing the image projected from the projection unit. With such an arrangement, for example, on the basis of the AR technology, the retinal projection HMD can superimpose the image of a virtual object on the optical image of a real object on the real space in accordance with the recognition result of at least any of the position and posture of the retinal projection HMD.

In the above, the exemplary exterior appearance configuration of the information processing device 100 according to the first embodiment has been described on the premise that the AR technology is applied. The exterior appearance configuration of the information processing device 100, however, is not limited to the above example. For example, assuming that VR technology is applied, the information processing device 100 may be provided as an HMD called an immersive HMD. Similarly to the video see-through HMD, the immersive HMD is worn so as to cover the user's eyes, and a display unit such as a display is held in front of the user's eyes. Thus, it is difficult that the outside scenery (i.e., real space) directly comes within the field of view of the user wearing the immersive HMD, so that only a picture displayed on the display unit comes within the field of view. In this case, in the immersive HMD, control is performed such that both of a captured real space and a superimposed virtual object are displayed on the display unit. That is, in the immersive HMD, instead of superimposing a virtual object on a transparent real space, the virtual object is superimposed on a captured real space, and both of the real space and the virtual object are displayed on the display. Even with such an arrangement, the information processing according to the present disclosure can be achieved.

### 1-3. Configuration of Information Processing Device According to First Embodiment

Next, an information processing system 1 that performs the information processing according to the present disclosure will be described with reference to FIG. 3. In the first embodiment, the information processing system 1 includes the information processing device 100. FIG. 3 is a diagram illustrating an exemplary configuration of the information processing device 100 according to the first embodiment of the present disclosure.

As illustrated in FIG. 3, the information processing device 100 includes the sensor 20, the control unit 30, a storage unit 50, and an output unit 60.

As described with reference to FIG. 2, the sensor 20 is a device or element that senses various types of information related to the information processing device 100.

The control unit 30 is achieved by a central processing unit (CPU), a micro processing unit (MPU), or the like executing a program (e.g., information processing program according to the present disclosure) stored in the information processing device 100, in a random access memory (RAM) or the like as a working area. Furthermore, the control unit 30 is a controller, and, for example, may be achieved by an integrated circuit such as an application specific integrated circuit (ASIC) or a field programmable gate array (FPGA).

As illustrated in FIG. 3, the control unit 30 includes a recognition unit 31, an acquisition unit 32, and an output control unit 33, and achieves or performs functions and operations of information processing described below. Note that the internal configuration of the control unit 30 is not limited to that illustrated in FIG. 3, and thus may be another configuration if the information processing described later is performed with the other configuration. Note that the control unit 30 may be connected to a predetermined network wiredly or wirelessly using, for example, a network interface card (NIC) or the like, and may receive various pieces of information from an external server or the like via the network.

The recognition unit 31 performs recognition processing on various types of information. For example, the recognition unit 31 controls the sensor 20 and senses various pieces of information with the sensor 20. Then, the recognition unit 31 performs recognition processing on the various pieces of information on the basis of the information sensed by the sensor 20.

For example, the recognition unit 31 recognizes where a user's hand is present on the space. Specifically, the recognition unit 31 recognizes the position of the user's hand on the basis of a picture captured by a recognition camera that is an example of the sensor 20. For such hand recognition processing, the recognition unit 31 may use various known techniques related to sensing.

For example, the recognition unit 31 analyzes a captured image acquired by the camera included in the sensor 20 and performs recognition processing on the real object present on the real space. The recognition unit 31 collates the image feature amount extracted from the captured image with the image feature amount of a known real object (specifically, an object operated by the user such as the user's hand) stored in the storage unit 50, for example. Then, the recognition unit 31 identifies the real object in the captured image and recognizes the position in the captured image. Furthermore, the recognition unit 31 analyzes the captured image acquired by the camera included in the sensor 20 and acquires the three-dimensional shape information on the real space. For example, the recognition unit 31 may perform a stereo matching technique for plurality of images acquired simultaneously, a structure from motion (SfM) technique for a plurality of images acquired chronologically, a SLAM technique, or the like, and may recognize a three-dimensional shape on the real space to acquire the three-dimensional shape information. In addition, in a case where the recognition unit 31 can acquire such three-dimensional shape information on the real space, the recognition unit 31 may recognize the three-dimensional position, shape, size, and posture of the real object.

Furthermore, as well as the real object, the recognition unit 31 may recognize user information related to the user and environmental information related to the environment in which the user is placed, on the basis of sensing data sensed by the sensor 20.

The user information includes, for example, action information indicating a user's action, motion information indicating a user's motion, biometric information, gaze information, and the like. The action information is information indicating the current action of the user, for example, while being stationary, walking, running, driving a vehicle, and going up and down stairs, and is recognized by analysis of sensing data such as acceleration acquired by the sensor 20. In addition, the motion information is information regarding, for example, movement velocity, movement direction, movement acceleration, and approach to the position of a content, and is recognized from sensing data such as acceleration and global positioning system (GPS) data acquired by the sensor 20. In addition, the biometric information is information regarding, for example, the user's heart rate, body temperature and sweating, blood pressure, pulse, respiration, blinking, eyeball movement, and brain waves, and is recognized on the basis of sensing data acquired by a biosensor included in the sensor 20. In addition, the gaze information is information related to the user's gaze such as the line-of-sight, gaze point, focal point, and convergence of both eyes, and is recognized on the basis of sensing data acquired by a visual sensor included in the sensor 20.

In addition, the environmental information includes information regarding, for example, such peripheral situation, place, illuminance, altitude, temperature, wind direction, air flow, and time. The information regarding the peripheral situation is recognized by analysis of sensing data acquired by the camera and a microphone included in the sensor 20. In addition, the place information may be information indicating the characteristics of the place where the user is present such as indoor, outdoor, underwater, and dangerous place, or may be information indicating meaning for the user in a place such as home, office, familiar place, and first-time visit place. The place information is recognized by analysis of sensing data acquired by the camera, the microphone, a GPS sensor, and an illuminance sensor included in the sensor 20. In addition, information regarding the illuminance, altitude, temperature, wind direction, air flow, and time (e.g., GPS time) may be similarly recognized on the basis of sensing data acquired from various types of sensors included in the sensor 20.

The acquisition unit 32 acquires a change in the distance between a first object operated by the user on the real space and a second object displayed on the display unit 61.

The acquisition unit 32 acquires the change in the distance between the second object displayed on the display unit 61 as a virtual object superimposed on the real space and the first object. That is, the second object is a virtual object superimposed in the display unit 61, with the AR technology or the like.

The acquisition unit 32 acquires information related to a user's hand detected by the sensor 20 as the first object. That is, the acquisition unit 32 acquires the change in the distance between the user's hand and the virtual object on the basis of the spatial coordinate position of the user's hand recognized by the recognition unit 31 and the spatial coordinate position of the virtual object displayed on the display unit 61.

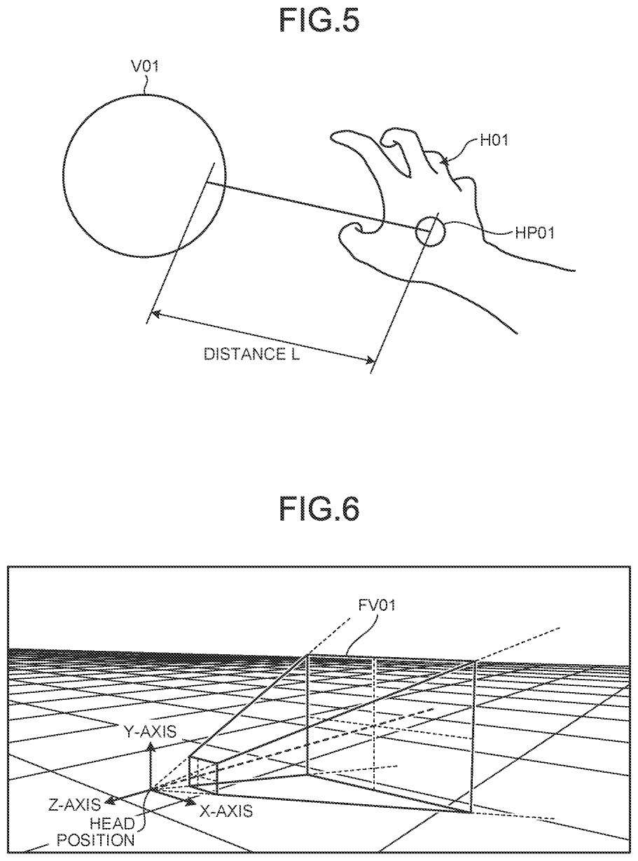

The information acquired by the acquisition unit 32 will be described with reference to FIG. 5. FIG. 5 is an explanatory illustration (1) of the information processing according to the first embodiment of the present disclosure. The example in FIG. 5 schematically illustrates a relationship between a user's hand H01, a distance L acquired by the acquisition unit 32, and a virtual object V01.

In a case where the hand H01 is recognized by the recognition unit 31, the acquisition unit 32 sets coordinates HP01 included in the recognized hand H01. For example, the coordinates HP01 are set at the substantial center of the recognized hand H01. Furthermore, the acquisition unit 32 sets, in the virtual object V01, coordinates that are recognized that the user's hand has touched the virtual object V01. In this case, the acquisition unit 32 sets not only the coordinates for only one point but also coordinates for a plurality of points in order to have some spatial expanse. It is difficult for the user to touch accurately the coordinates for one point in the virtual object V01 with his/her hand. Thus, a certain spatial range is set in order to facilitate to some extent in “touching” the virtual object V01 by the user.

Then, the acquisition unit 32 acquires the distance L between the coordinates HP01 and any coordinates set in the virtual object V01 (may be any specific coordinates, or may be the center point, center of gravity, or the like of the coordinates for the plurality of points).

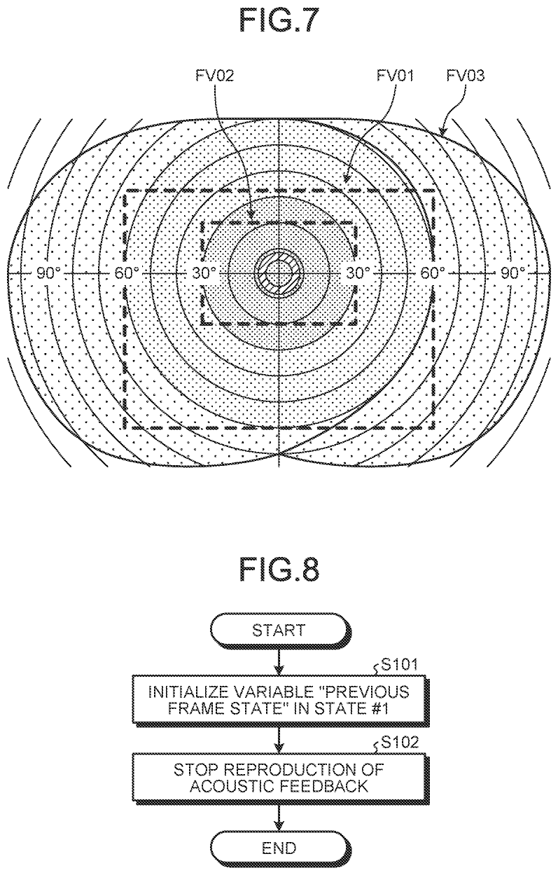

Subsequently, with reference to FIGS. 6 and 7, there will be described the processing performed in acquisition of the distance between the hand H01 and the virtual object V01 by the acquisition unit 32. FIG. 6 is an explanatory illustration (2) of the information processing according to the first embodiment of the present disclosure. FIG. 6 illustrates the angle of view at which the information processing device 100 recognizes an object, as viewed from the position of the user's head. An area FV01 indicates the range in which the sensor 20 (recognition camera) can recognize the object. That is, the information processing device 100 can recognize the spatial coordinates of any object included in the area FV01.

Subsequently, the angle of view that can be recognized by the information processing device 100 will be described with reference to FIG. 7. FIG. 7 is an explanatory illustration (3) of the information processing according to the first embodiment of the present disclosure. FIG. 7 schematically illustrates a relationship between the area FV01 indicating the angle of view covered by the recognition camera, an area FV02 that is the display area of the display (display unit 61), and an area FV03 indicating the field angle of view of the user.

When the recognition camera covers the area FV01, the acquisition unit 32 can acquire the distance between the hand H01 and the virtual object V01 in a case where the hand H01 is present inside the area FV01. On the other hand, the acquisition unit 32 cannot recognize the hand H01 in a case where the hand H01 is present outside the area FV01, and thus the acquisition unit 32 cannot acquire the distance between the hand H01 and the virtual object V01. Note that as will be described later, the user can receive acoustic feedback that varies between the case where the hand H01 is present outside the area FV01 and the case where the hand H01 is present inside the area FV01, so that the user can determine that the hand H01 has been recognized by the information processing device 100.

The output control unit 33 performs first control such that the mode of an output signal is continuously changed on the basis of the change in the distance acquired by the acquisition unit 32.

For example, the output control unit 33 outputs a signal for causing the vibration output device to output sound as an output signal. The vibration output device is, for example, an acoustic output unit 62 included in the information processing device 100, an earphone worn by the user, a wireless speaker communicable with the information processing device 100, and the like.

As the first control, the output control unit 33 performs control such that the mode of the output sound signal is continuously changed on the basis of the change in the distance acquired by the acquisition unit 32. Specifically, the output control unit 33 continuously changes at least one of the volume, cycle, or frequency of the output sound on the basis of the change in the distance acquired by the acquisition unit 32. That is, the output control unit 33 performs acoustic feedback such as outputting a high volume or outputting effect sound at a short cycle in accordance with the change in the distance between the user's hand and the virtual object. Note that as illustrated in FIG. 1, the continuous change means a one-way change (in the example of FIG. 1, an increase in volume, cycle, and the like) as the user's hand approaches the virtual object. As illustrated in FIG. 1, the continuous change includes a stepwise increase in volume and an increase in cycle at predetermined distances.

Note that the output control unit 33 may stop the first control when the distance between the first object and the second object reaches a predetermined threshold or less. For example, in a case where the user's hand has reached a distance where the user's hand and the virtual object are recognized as having touched each other, the output control unit 33 may stop the acoustic feedback for continuously changing the output, and, for example, may output specific effect sound indicating that user's hand and the virtual object touched each other.

The output control unit 33 may determine the output volume, cycle, and the like on the basis of a change in a predefined distance, for example. That is, the output control unit 33 may read a definition file for setting the volume and the like to change continuously and may adjust an output sound signal as the distance between the hand and the virtual object is shorter. For example, the output control unit 33 controls the output with reference to the definition file stored in the storage unit 50. More specifically, the output control unit 33 refers to the definition (setting information) of the definition file stored in the storage unit 50 as a variable, and controls the volume and cycle of the output sound signal.

Here, the storage unit 50 will be described. The storage unit 50 is achieved by, for example, a semiconductor memory element such as a RAM or a flash memory, or a storage device such as a hard disk or an optical disk. The storage unit 50 is a storage area for temporarily or permanently storing various types of data. For example, the storage unit 50 may store data for performing various functions (e.g., information processing program according to the present disclosure) by the information processing device 100. Furthermore, the storage unit 50 may store data (e.g., library) for execution of various types of applications, management data for managing various types of settings, and the like. For example, the storage unit 50 according to the first embodiment has output definition data 51 as a data table.

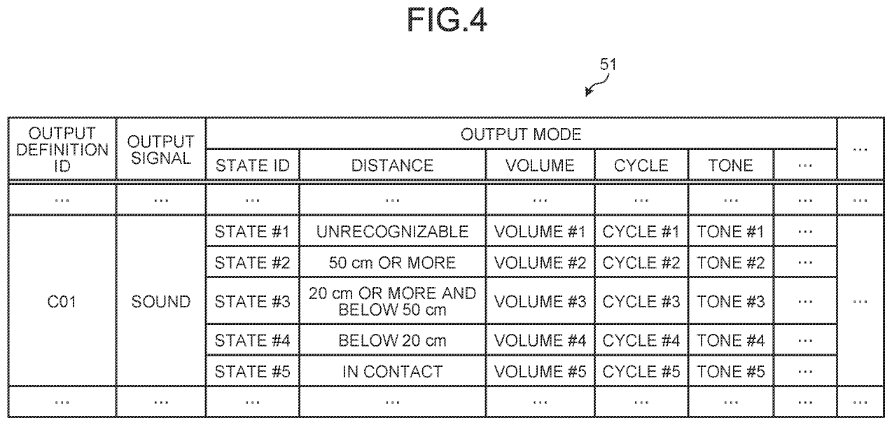

Here, there will be described the output definition data 51 according to the first embodiment with reference to FIG. 4. FIG. 4 illustrates an example of the output definition data 51 according to the first embodiment of the present disclosure. In the example illustrated in FIG. 4, the output definition data 51 has items such as “output definition ID”, “output signal”, and “output mode”. Furthermore, the “output mode” has sub items such as “state ID”, “distance”, “volume”, “cycle”, and “tone”.

The “output definition ID” is identification information for identifying data that stores the definition of the mode of an output signal. The “output signal” is a type of signal that the output control unit 33 outputs. The “output mode” is a specific output mode.

The “state ID” is information indicating in what state the relationship between the first object and the second object is. The “distance” is a specific distance between the first object and the second object. Note that “unrecognizable” distance means, for example, a state where the user's hand is at the position that is not sensed by the sensor 20 and the distance between the objects is not acquired. In other words, the “unrecognizable” distance is a state where the first object is present outside the area FV01 illustrated in FIG. 7.

In addition, as illustrated in FIG. 4, “state #2” indicates that the distance between the first object and the second object is “50 cm or more”, and this state indicates a state where the first object (user's hand) is present in the area A01 illustrated in FIG. 1. Similarly, “state #3” indicates a state where the first object is present in the area A02 illustrated in FIG. 1, “state #4” indicates a state where the first object is present in the area A03 illustrated in FIG. 1, and “state #5” indicates a state where the first object is present in the area A04 illustrated in FIG. 1.

The “volume” is information indicating at what volume the signal is output in the corresponding state. Note that in the example of FIG. 4, an example is illustrated in which conceptual information such as “volume #1” is stored in the item of volume. However, practically, a specific numerical value or the like indicating the output volume is stored the item of volume. This also applies similarly to the items of cycle and tone described later. The “cycle” is information indicating at which cycle the signal is output in the corresponding state. The “tone” is information indicating with what kind of tone (in other words, a waveform) the signal is output in the corresponding state. Note that although not illustrated in FIG. 4, the output definition data 51 may store information related to elements that can be included in sound other than the volume, cycle, and tone.

That is, in the example illustrated in FIG. 4, the data defined by the output definition ID “C01” indicates that the output signal is related to “sound”. In addition, in a case where the state ID is “state #1”, that is, the distance between the first object and the second object is “unrecognizable”, the output mode indicates that the volume is “volume #1”, the cycle is “cycle #1”, and the tone is “tone #1”. Note that the “state #1” is a state in which the first object has not been recognized, and thus the information processing device 100 does not necessarily output a sound signal. In this case, the items such as “volume #1” and “cycle #1” store information indicating that the volume and cycle are not generated.

Furthermore, in the example illustrated in FIG. 4, as a sound output mode, there has been exemplified that the volume and the like continuously change on the basis of any state of the five stages. The sound output mode, however, is not limited to this example. That is, the output control unit 33 may perform output control such that the distance between the first object and the second object, the output volume, and the like are continuously changed in conjunction with each other.

The output unit 60 includes the display unit 61 and the acoustic output unit 62, and is controlled by the output control unit 33 to output various pieces of information. For example, the display unit 61 displays a virtual object superimposed on a transparent real space. In addition, the acoustic output unit 62 outputs a sound signal.

### 1-4. Procedure of Information Processing According to First Embodiment

Next, the procedure of the information processing according to the first embodiment will be described with reference to FIGS. 8 to 10. FIG. 8 is a flowchart (1) illustrating the flow of the processing according to the first embodiment of the present disclosure.

As illustrated in FIG. 8, the information processing device 100 first inputs “state #1” to the variable “previous frame state” to initialize acoustic feedback (step S101). In the example of FIG. 8, in the case of “state #1”, the information processing device 100 temporarily stops the reproduction of the acoustic feedback (step S102).

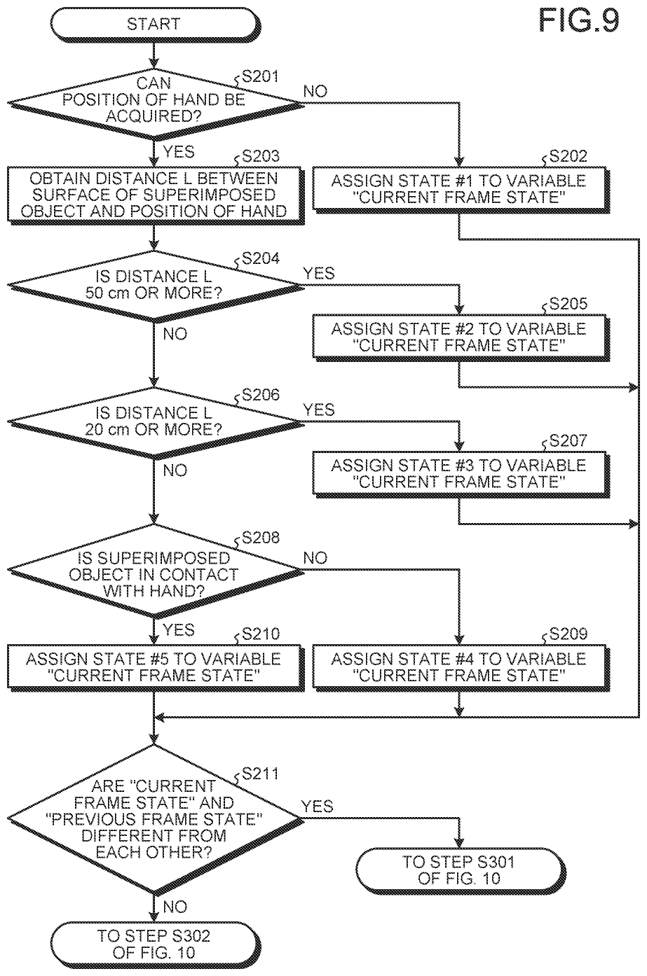

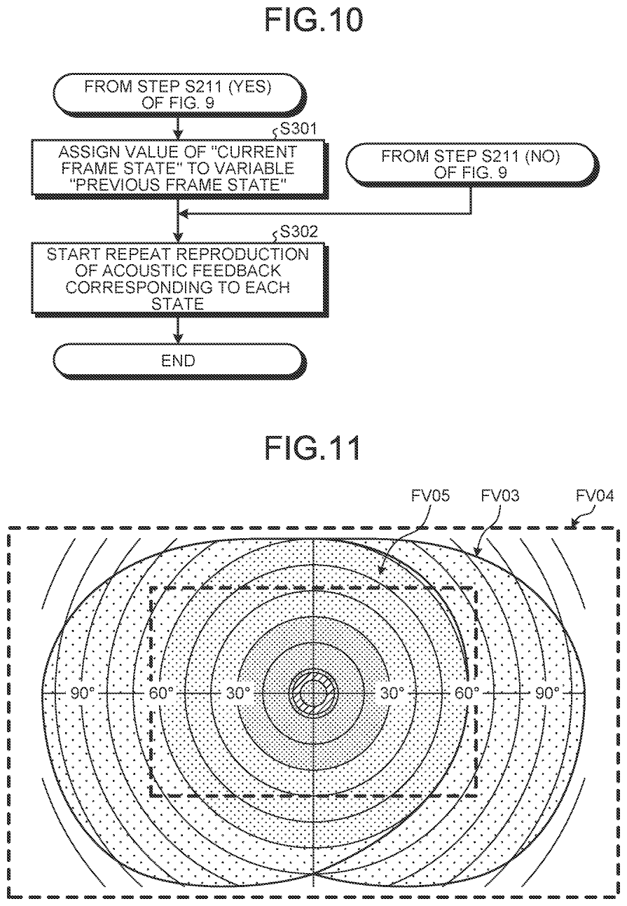

Next, the procedure of information processing when the information processing device 100 performs acoustic feedback will be described with reference to FIG. 9. FIG. 9 is a flowchart (2) illustrating the flow of the processing according to the first embodiment of the present disclosure.

First, the information processing device 100 determines whether or not the position of the user's hand can be acquired with the sensor 20 (step S201). In a case where the position of the user's hand cannot be acquired (step S201; No), the information processing device 100 refers to output definition data 51 in the storage unit 50, and assigns “state #1” that is a state corresponding to the situation where the position of the user's hand cannot be acquired, to the variable “current frame state” (step S202).

On the other hand, in a case where the position of the user's hand has been successfully acquired (step S201; Yes), the information processing device 100 obtains the distance L between the surface of a superimposed object (e.g., the range in which it is recognized that the hand H01 has touched the virtual object V01 illustrated in FIG. 5) and the hand (step S203). The information processing device 100 further determines whether or not the distance L is 50 cm or more (step S204).

In a case where the distance L is 50 cm or more (step S204; Yes), the information processing device 100 refers to the output definition data 51 and assigns “state #2” that is a state corresponding to the situation where the distance L is 50 cm or more, to the variable “current frame state” (step S205).

On the other hand, in a case where the distance L is not 50 cm or more (step S204; No), the information processing device 100 further determines whether or not the distance L is 20 cm or more (step S206). In a case where the distance L is 20 cm or more (step S206; Yes), the information processing device 100 refers to the output definition data 51 and assigns “state #3” that is a state corresponding to the situation where the distance L is 20 cm or more, to the variable “current frame state” (step S207).

On the other hand, in a case where the distance L is not 20 cm or more (step S206; No), the information processing device 100 further determines whether or not the superimposed object is in contact with the hand (i.e., the distance L is 0) (step S208). In a case where the superimposed object is not in contact with the hand (step S208; No), the information processing device 100 refers to the output definition data 51 and assigns, to the variable “current frame state”, “state #4” that is a state corresponding to the situation where the distance L is below 20 cm and the superimposed object is not in contact with the hand (step S209).

On the other hand, in a case where the superimposed object is in contact with the hand (step S208; Yes), the information processing device 100 refers to the output definition data 51 and assigns “state #5” that is a state corresponding to the situation where the superimposed object is in contact with the hand, to the variable “current frame state” (step S210).

Then, the information processing device 100 determines whether or not the “current frame state” and the “previous frame state” are different from each other (step S211). The information processing device 100 performs acoustic feedback in accordance with the results of such determination. The performance of the acoustic feedback will be described with reference to FIG. 10.

FIG. 10 is a flowchart (3) illustrating the flow of the processing according to the first embodiment of the present disclosure. In a case where it is determined in step S211 of FIG. 9 that the “current frame state” and the “previous frame state” are different from each other (step S211; Yes), the information processing device 100 assigns the “current frame state” to the variable “previous frame state” (step S301).

Note that in a case where it is determined in step S211 of FIG. 9 that the “current frame state” and the “previous frame state” are the same (step S211; No), the information processing device 100 skips the processing of step S301.

Then, the information processing device 100 starts repeat reproduction of the acoustic feedback corresponding to each state (step S302). The repeat reproduction means, for example, continuous output of effect sound at a continuous cycle. The information processing device 100 repeats the processing of FIGS. 9 and 10 every frame (e.g., 30 times per second or 60 times per second) captured by the sensor 20.

### 2. Second Embodiment

### 2-1. Overview of Information Processing According to Second Embodiment

Next, a second embodiment will be described. There has been exemplified in the first embodiment that the information processing device 100 acquires the distance between the user's hand present within the range of the angle of view recognizable by the sensor 20 (recognition camera) and the superimposed object on the real space, and performs the acoustic feedback in accordance with the acquired distance. In the second embodiment, there will be exemplified that acoustic feedback is performed for a situation in which, for example, a user's hand present out of the range of the angle of view recognizable by the recognition camera is newly included in the angle of view.

FIG. 11 is an explanatory illustration (1) of the information processing according to the second embodiment of the present disclosure. Similarly to FIG. 7, FIG. 11 conceptually illustrates the angle of view recognizable by the information processing device 100.

Here, in the second embodiment, it is assumed that an area FV04 covered by the recognition camera is wider than an area FV03 indicating the field angle of view of the user. Note that an area FV05 illustrated in FIG. 11 is the display area of a display according to the second embodiment.

As illustrated in FIG. 11, in the case where the area FV04 covered by the recognition camera is wider than the area FV03 that is the field angle of view of the user, it is likely that the information processing device 100 recognizes the presence of the user's hand even though the user cannot see his/her hand. On the other hand, as illustrated in FIG. 7, in the case where the area FV02 covered by the recognition camera is narrower than the area FV03, it is likely that the information processing device 100 does not recognize the presence of the user's hand even though the user can see his/her hand. That is, in a technology such as AR technology for recognizing an object present on the real space, discrepancy may occur between the perception of the user and the recognition by the information processing device 100. Thus, such discrepancy may impair user experience, for example, the user feels anxiety about whether or not his/her hand has been recognized, or no recognition has been made even in the case of performing the operation.

Therefore, in the information processing according to the second embodiment, not only acoustic feedback based on the distance between the user's hand and an object superimposed on the real space, but also acoustic feedback is performed in accordance with the recognition of the user's hand. This allows the user to acoustically determine how his/her hand has been recognized by the information processing device 100, so that an accurate operation can be performed in the AR technology or the like. Hereinafter, an information processing system 2 that performs the information processing according to the second embodiment will be described.

### 2-2. Configuration of Information Processing Device According to Second Embodiment

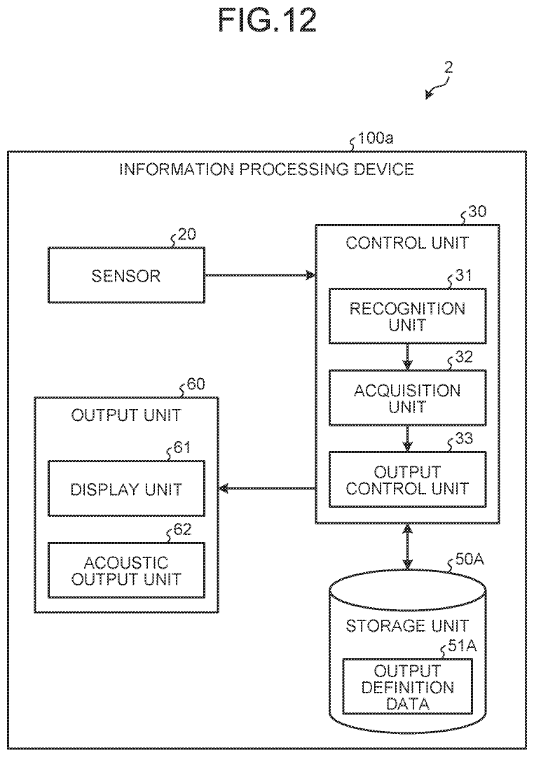

The information processing system 2 that performs the information processing according to the present disclosure will be described with reference to FIG. 12. In the second embodiment, the information processing system 2 includes an information processing device 100a. FIG. 12 is a diagram illustrating an exemplary configuration of the information processing device 100a according to the second embodiment of the present disclosure. Note that the description of the configuration common to that of the first embodiment will be omitted.

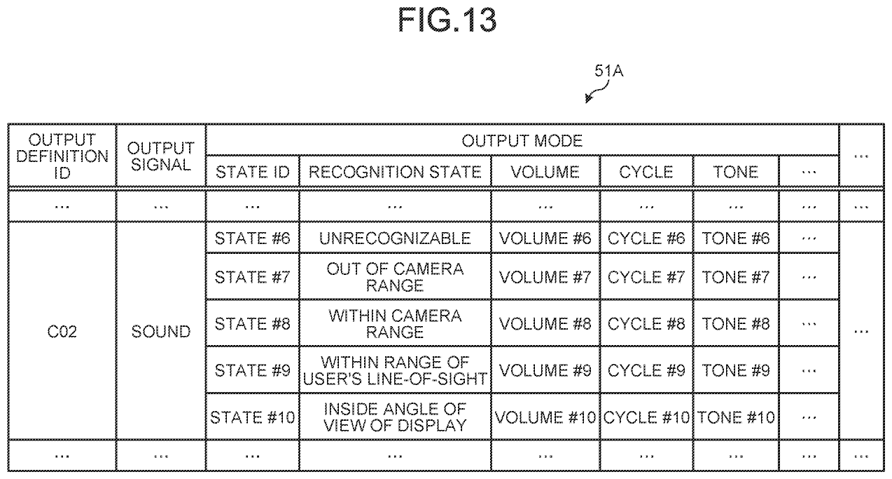

The information processing device 100a according to the second embodiment has output definition data 51A in a storage unit 50A. There will be described the output definition data 51A according to the second embodiment with reference to FIG. 13. FIG. 13 illustrates an example of the output definition data 51A according to the second embodiment of the present disclosure. In the example illustrated in FIG. 13, the output definition data 51 has items such as “output definition ID”, “output signal”, and “output mode”. Furthermore, the “output mode” has sub items such as “state ID”, “recognition state”, “volume”, “cycle”, and “tone”.

The “recognition state” indicates how a first object (e.g., the user's hand) operated by the user has been recognized by the information processing device 100a. For example, “unrecognizable” means a state where the first object has not been recognized by the information processing device 100a. In addition, “out of camera range” indicates a case where the first object is present outside the angle of view of the recognition camera. Note that a case where the first object is “out of camera range” and the information processing device 100a has already recognized the first object means, for example, a state where due to transmission of some kind of signal from the first object (e.g., communication related to pairing), the first object has been sensed by another sensor, although the camera has not recognized the first object.

Furthermore, “within camera range” indicates a case where the first object is present inside the angle of view of the recognition camera. Still furthermore, “within range of user's line-of-sight” indicates a case where the first object has already been recognized at the angle of view corresponding to the user's vision. Note that the angle of view corresponding to the user's vision may be, for example, a predefined angle of view in the typically assumed average field of view of human. Still furthermore, “inside angle of view of display” indicates a case where the first object is present inside the angle of view in the range displayed on the display unit 61 of the information processing device 100a.

That is, in the information processing according to the second embodiment, the information processing device 100a controls output of a sound signal in accordance with the state where the information processing device 100a has recognized the first object (in other words, position information of the object). Such processing is referred to as “second control” in order to distinguish the processing from that in the first embodiment.

For example, an acquisition unit 32 according to the second embodiment acquires position information indicating the position of the first object, with a sensor 20 having a detection range exceeding the angle of view of the display unit 61. Specifically, the acquisition unit 32 acquires the position information indicating the position of the first object, with the sensor 20 having a detection range wider than the angle of view of the display unit 61 as viewed from the user. More specifically, the acquisition unit 32 uses the sensor 20 having a detection range wider than the angle of view displayed on such a transparent display as the display unit 61 (in other words, the viewing angle of the user). That is, the acquisition unit 32 acquires the motion of the user's hand or the like that is not displayed on the display and is difficult for the user to give recognition. Then, on the basis of the position information acquired by the acquisition unit 32, an output control unit 33 according to the second embodiment performs the second control such that the mode of an output signal is changed. In other words, the output control unit 33 changes vibration output from a vibration output device on the basis of the acquired position information.

For example, as the second control, the output control unit 33 continuously changes the mode of the output signal in accordance with the approach of the first object to the boundary of the detection range of the sensor 20. That is, the output control unit 33 changes vibration output from the vibration output device in accordance with the approach of the first object to the boundary of the detection range of the sensor 20. This allows the user to perceive that, for example, the hand is unlikely to be detected by the sensor 20.

As the details will be described later, the output control unit 33 controls output of an output signal that varies in mode between a case where the first object approaches the boundary of the detection range of the sensor 20 from outside the angle of view of the display unit 61 and a case where the first object approaches the boundary of the detection range of the sensor 20 from inside the angle of view of the display unit 61. In other words, the output control unit 33 makes vibration output vary between the case of approaching the boundary of the detection range of the sensor 20 from outside the angle of view of the display unit 61 and the case of approaching the boundary of the detection range of the sensor 20 from inside the angle of view of the display unit 61.

In addition, the acquisition unit 32 may acquire not only the position information of the first object but also position information of a second object on the display unit 61. In this case, the output control unit 33 changes the mode of the output signal in accordance with the approach of the second object from inside the angle of view of the display unit 61 to the vicinity of the boundary between the inside and outside the angle of view of the display unit 61.

In addition, the acquisition unit 32 may acquire information indicating that the first object has transitioned from a state where the first object is undetectable by the sensor 20 to a state where the first object is detectable by the sensor 20. Then, in a case where the information indicating that the first object has transitioned to the state that the first object is detectable by the sensor 20 is acquired, the output control unit 33 may change the vibration output (mode of the output signal) from the vibration output device. Specifically, in a case where the sensor 20 has newly sensed the user's hand, the output control unit 33 may output effect sound indicating the sensing. As a result, the user can dispel the anxiety about whether or not his/her hand has been recognized.

Note that as will be described later, the output control unit 33 outputs a sound signal in the first control and outputs a different type of signal (e.g., a signal related to vibration) in the second control, so that the user can perceive these controls separately even in the case of using together the first control and the second control. Furthermore, the output control unit 33 may perform control of, for example, making the tone vary between a sound signal in the first control and a sound signal in the second control.

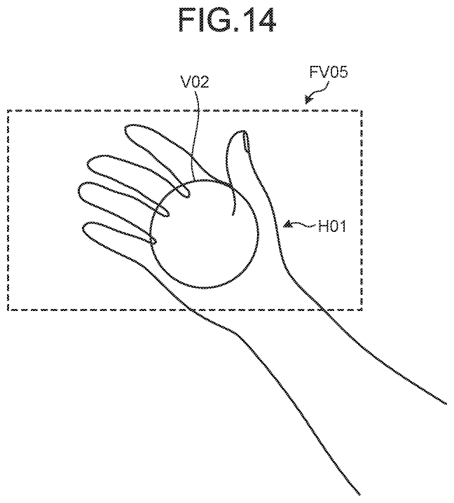

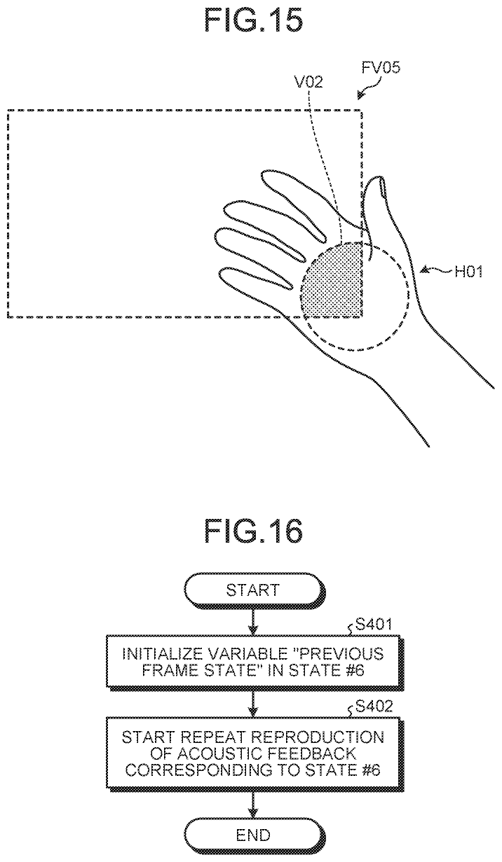

As above, the output control unit 33 acquires the position information of the first object and second object, so that the user can be notified of a state where the first object is likely to move out from inside the angle of view of the display or inside the angle of view of the camera, for example. This notification will be described with reference to FIGS. 14 and 15.

FIG. 14 is an explanatory illustration (2) of the information processing according to the second embodiment of the present disclosure. FIG. 14 illustrates a state where a user's hand H01 and a virtual object V02 are displayed in the area FV05 that is the angle of view of the display. In the example of FIG. 14, it is assumed that the user holds the virtual object V02 that is movable with the user's hand H01 on an AR space. That is, moving his/her hand H01 allows the user to move the virtual object V02 in the display unit 61.

FIG. 15 illustrates a state where the user has moved the virtual object V02 to the vicinity of the outside of the screen. FIG. 15 is an explanatory illustration (3) of the information processing according to the second embodiment of the present disclosure. FIG. 15 illustrates a state where the virtual object V02 is about to be moved out of the area FV05 due to the movement of the virtual object V02 to the vicinity of the outside of the screen by the user.

The virtual object V02 is superimposed on the real space only in the display unit 61, and thus the display disappears in a case where the virtual object V02 has been moved out of the area FV05. Thus, the information processing device 100a may control of output an acoustic signal with such movement of the virtual object V02 by the user. For example, the information processing device 100a may output sound such as alarming sound indicating that the virtual object V02 has approached the outside of the screen, in accordance with a recognition state of the virtual object V02 (in other words, a recognition state of the user's hand H01). This allows the user to grasp easily a state where the virtual object V02 is about to move out to the outside of the screen. In such a manner, the information processing device 100a controls output of sound in accordance with the recognition state of an object, so that the spatial recognition by the user can be improved.

### 2-3. Procedure of Information Processing According to Second Embodiment

Next, the procedure of the information processing according to the second embodiment will be described with reference to FIGS. 16 to 18. FIG. 16 is a flowchart (1) illustrating the flow of the processing according to the second embodiment of the present disclosure.

As illustrated in FIG. 16, the information processing device 100a first inputs “state #6” to the variable “previous frame state” to initialize acoustic feedback (step S401). In the example of FIG. 16, the information processing device 100a starts repeat reproduction of the acoustic feedback corresponding to the “state #6” (step S402). Note that the information processing device 100a may stop the acoustic feedback similarly to that illustrated in FIG. 8 depending on the defined content.

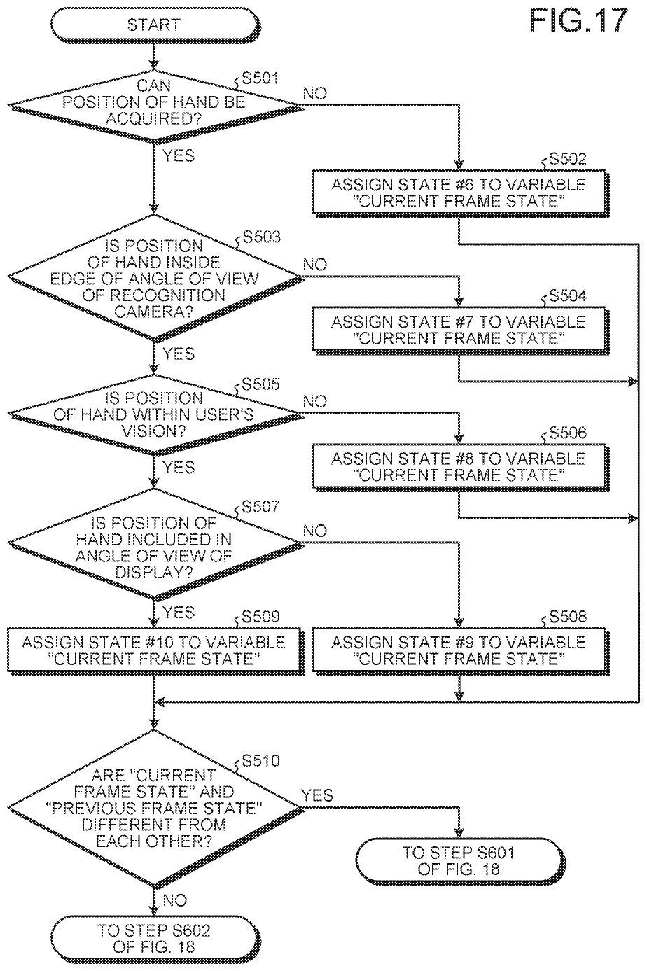

Next, the procedure of information processing when the information processing device 100a performs acoustic feedback will be described with reference to FIG. 17. FIG. 17 is a flowchart (2) illustrating the flow of the processing according to the second embodiment of the present disclosure.

First, the information processing device 100a determines whether or not the position of the user's hand can be acquired with the sensor 20 (step S501). In a case where the position of the user's hand cannot be acquired (step S501; No), the information processing device 100a refers to output definition data 51A and assigns “state #6” that is a state corresponding to the situation where the position of the user's hand cannot be acquired, to the variable “current frame state”(step S502).

On the other hand, in a case where the position of the user's hand can be acquired (step S501; Yes), the information processing device 100a determines whether or not the position of the hand is inside the edge of the angle of view of the recognition camera (step S503).

In a case where the position of the hand is not inside the edge of the angle of view of the recognition camera (step S503; No), the information processing device 100a refers to the output definition data 51A, and assigns “state #7” that is a state corresponding to the situation where the position of the hand is out of the range of the recognition camera, to the variable “current frame state” (step S504).

On the other hand, in the case where the position of the hand is inside the edge of the angle of view of the recognition camera (step S503; Yes), the information processing device 100a further determines whether or not the position of the hand is within the user's vision (step S505).

In a case where the position of the hand is not within the user's vision (step S505; No), the information processing device 100a refers to the output definition data 51A, and assigns “state #8” that is a state corresponding to the situation where the hand is within the range of the recognition camera and outside the field angle of view of the user, to the variable “current frame state” (step S506).

On the other hand, in a case where the position of the hand is within the user's vision (step S505; Yes), the information processing device 100a further determines whether or not the position of the hand is included in the angle of view of the display (step S507).

In a case where the position of the hand is not included in the angle of view of the display (step S507; No), the information processing device 100a refers to the output definition data 51A, and assigns “state #9” that is a state corresponding to the situation where the position of the hand is outside the angle of view of the display and within the range of the field of view of the user, to the variable “current frame state” (step S508).

On the other hand, in a case where the position of the hand is included in the angle of view of the display (step S507; Yes), the information processing device 100a refers to the output definition data 51A and assigns “state #10” that is a state corresponding to the situation where the position of the hand is inside the angle of view of the display, to the variable “current frame state” (step S509).

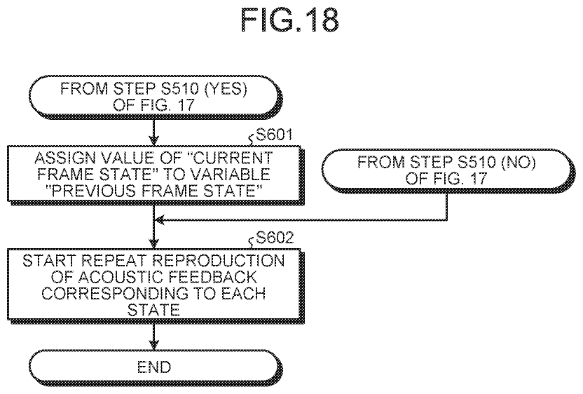

Then, the information processing device 100a determines whether or not the “current frame state” and the “previous frame state” are different from each other (step S510). The information processing device 100a performs acoustic feedback in accordance with the results of such determination. The performance of the acoustic feedback will be described with reference to FIG. 18.

FIG. 18 is a flowchart (3) illustrating the flow of the processing according to the second embodiment of the present disclosure. In a case where it is determined in step S510 of FIG. 17 that the “current frame state” and the “previous frame state” are different from each other (step S510; Yes), the information processing device 100a assigns the “current frame state” to the variable “previous frame state” (step S601).

Note that in a case where it is determined in step S510 of FIG. 17 that the “current frame state” and the “previous frame state” are the same (step S510; No), the information processing device 100a skips the processing of step S601.

Then, the information processing device 100a starts repeat reproduction of the acoustic feedback corresponding to each state (step S602). The repeat reproduction means, for example, continuous output of effect sound at a continuous cycle. The information processing device 100a repeats the processing of FIGS. 17 and 18 every frame (e.g., 30 times per second or 60 times per second) captured by the sensor 20.

### 3. Third Embodiment

### 3-1. Configuration of Information Processing System According to Third Embodiment

Next, a third embodiment will be described. In information processing of the present disclosure according to the third embodiment, output of a signal different from the sound signal is controlled.

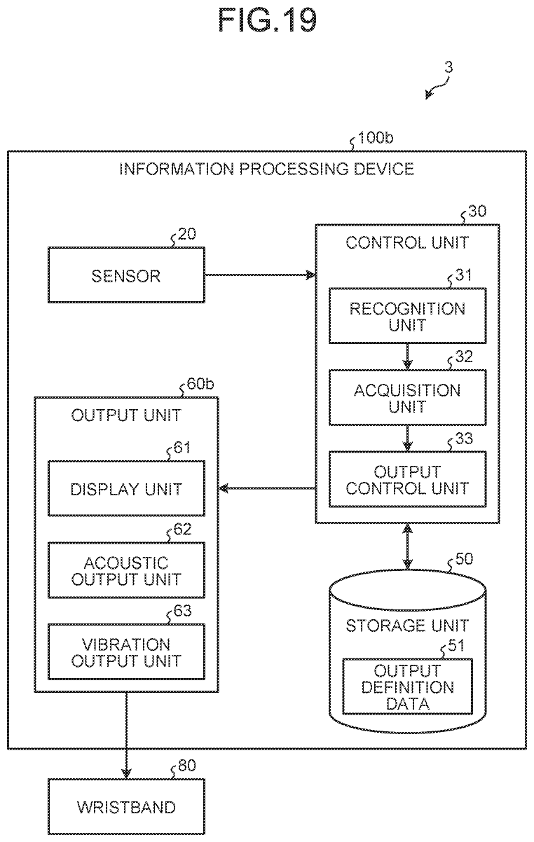

An information processing system 3 according to the third embodiment will be described with reference to FIG. 19. FIG. 19 is a diagram illustrating an exemplary configuration of the information processing system 3 according to the third embodiment of the present disclosure. As illustrated in FIG. 19, the information processing system 3 according to the third embodiment includes an information processing device 100b and a wristband 80. Note that the description of the configuration common to that of the first embodiment or the second embodiment will be omitted.

The wristband 80 is a wearable device that is worn on a user's wrist. The wristband 80 has a function of receiving a control signal from the information processing device 100b and vibrating in response to the control signal. That is, the wristband 80 is an example of the vibration output device according to the present disclosure.

The information processing device 100b includes a vibration output unit 63. The vibration output unit 63 is achieved by, for example, a vibration motor or the like, and vibrates in accordance with the control by the output control unit 33. For example, the vibration output unit 63 generates vibration having a predetermined cycle and a predetermined amplitude force in response to a vibration signal output from the output control unit 33. That is, the vibration output unit 63 is an example of the vibration output device according to the present disclosure.

In addition, a storage unit 50 stores a definition file having stored, for example, the cycle and magnitude of the output of the vibration signal according to a change in the distance between a first object and a second object (corresponding to the “first control” described in the first embodiment). Furthermore, the storage unit 50 stores a definition file having stored, for example, information related to a change in the cycle and magnitude of the output of the vibration signal according to a recognition state of the first object (control based on this information corresponds to the “second control” described in the second embodiment).

Then, the output control unit 33 according to the third embodiment outputs, as an output signal, a signal for causing the vibration output device to generate vibration. Specifically, the output control unit 33 refers to the above definition files and controls output of a vibration signal for vibrating the vibration output unit 63 or the wristband 80. That is, in the third embodiment, feedback to the user is performed not only with sound but also with vibration. With this arrangement, the information processing device 100b enables the perception of the user's tactile sense instead of the user's vision or auditory sense, so that the spatial recognition by the user can be further improved. Furthermore, the information processing device 100b can perform appropriate feedback even to, for example, a hearing-impaired user, and thus the information processing related to the present disclosure can be provided to a wide range of users.

### 4. Fourth Embodiment

### 4-1. Configuration of Information Processing System According to Fourth Embodiment

Next, a fourth embodiment will be described. In information processing of the present disclosure according to the fourth embodiment, as a first object, an object other than a user's hand is recognized.

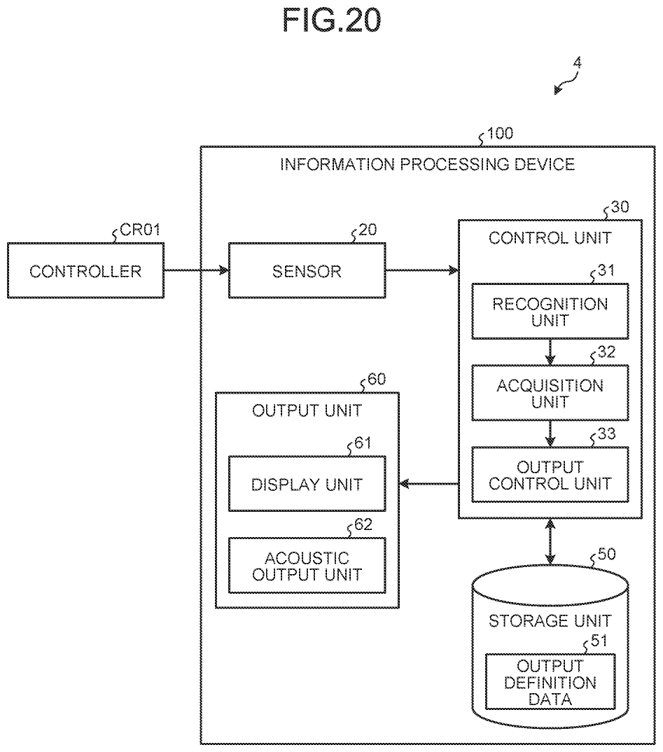

An information processing system 4 according to the fourth embodiment will be described with reference to FIG. 20. FIG. 20 is a diagram illustrating an exemplary configuration of the information processing system 4 according to the fourth embodiment of the present disclosure. As illustrated in FIG. 20, the information processing system 4 according to the fourth embodiment includes an information processing device 100 and a controller CR01. Note that the description of the configuration common to that of the first embodiment, the second embodiment, or the third embodiment will be omitted.

The controller CR01 is an information device connected to the information processing device 100 via a wired or wireless network. The controller CR01 is, for example, an information device held in a user's hand and operated by the user wearing the information processing device 100, and senses the motion of the user's hand and information input from the user to the controller CR01. Specifically, the controller CR01 controls built-in sensors (e.g., various types of motion sensors such as a three-axis accelerometer, a gyro sensor, and a velocity sensor) and senses the three-dimensional position, velocity, and the like of this controller CR01. Then, the controller CR01 transmits the sensed three-dimensional position, velocity, and the like to the information processing device 100. Note that the controller CR01 may transmit the three-dimensional position of this controller CR01 sensed by an external sensor such as an external camera. Furthermore, the controller CR01 may transmit information regarding pairing with the information processing device 100, position information (coordinate information) of this controller CR01, and the like by using a predetermined communication function.

The information processing device 100 according to the fourth embodiment recognizes, as a first object, not only the user's hand but also the controller CR01 that the user operates. Then, the information processing device 100 performs first control on the basis of a change in the distance between the controller CR01 and a virtual object. Alternatively, the information processing device 100 performs second control on the basis of the position information of the controller CR01. That is, an acquisition unit 32 according to the fourth embodiment acquires the change in the distance between the second object and the user's hand detected by the sensor 20 or the controller HR01 that the user operates, detected by the sensor.

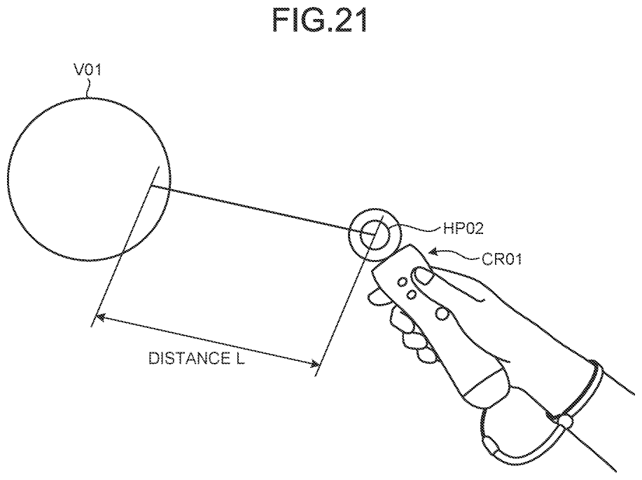

Here, the acquisition processing according to the fourth embodiment will be described with reference to FIG. 21. FIG. 21 is an explanatory illustration of the information processing according to the fourth embodiment of the present disclosure. The example in FIG. 21 schematically illustrates a relationship between the controller CR01 that the user operates, a distance L acquired by the acquisition unit 32, and a virtual object V01.

In a case where the controller CR01 is recognized by a recognition unit 31, the acquisition unit 32 specifies any coordinates HP02 included in the recognized controller CR01. The coordinates HP02 are a preset recognition point of the controller CR01, and is a point that can be easily recognized by the sensor 20, due to transmission of some kind of signal (e.g., infrared ray signal), for example.

Then, the acquisition unit 32 acquires the distance L between the coordinates HP02 and any coordinates set in the virtual object V01 (may be any specific coordinates, or may be the center point, center of gravity, or the like of the coordinates for a plurality of points).

In such a manner, the information processing device 100 according to the fourth embodiment may recognize not only the user's hand but also some kind of object such as the controller CR01 that the user operates, and may perform acoustic feedback on the basis of the recognized information. That is, the information processing device 100 can flexibly perform acoustic feedback according to various modes of user operation.

### 5. Modifications of Each Embodiment

The processing according to each of the above embodiments may be performed in various different modes in addition to each of the above embodiments.

There has been exemplified in each of the above embodiments that the information processing device 100 (including the information processing device 100a and the information processing device 100b) includes a built-in processing unit such as the control unit 30. The information processing device 100, however, may be separated into, for example, an eyeglass-type interface unit, a calculation unit including the control unit 30, and an operation unit that receives an input operation or the like from the user. In addition, as described in each embodiment, the information processing device 100 is a so-called AR glass in the case of including the display unit 61 having transparency and being held in the direction of the line-of-sight of the user. The information processing device 100, however, may be a device that communicates with the display unit 61 that is an external display, and performs display control on the display unit 61.

Furthermore, the information processing device 100 may use an external camera installed in another place as a recognition camera, instead of the sensor 20 provided in the vicinity of the display unit 61. For example, in AR technology, a camera may be installed, for example, on the ceiling of a place where the user acts such that the entire motion of the user wearing AR goggles can be captured. In such a case, the information processing device 100 may acquire a picture captured by the externally installed camera, via a network and may recognize the position of a hand of the user or the like.

Furthermore, there has been exemplified in each of the above embodiments that the information processing device 100 changes the output mode on the basis of the state according to the distance between the user's hand and the virtual object. The mode, however, is not necessarily changed for each state. For example, the information processing device 100 may assign, as a variable, the distance L between the user's hand the virtual object to a function for determining the volume, cycle, frequency, and the like, and may determine the output mode.

Furthermore, the information processing device 100 does not necessarily output a sound signal in a mode such as effect sound repeated periodically. For example, in a case where the user's hand has been recognized by a camera, the information processing device 100 may continue to reproduce constantly steady sound indicating that the user's hand has been recognized. Then, in a case where the user's hand has moved in a direction of the virtual object, the information processing device 100 may allow output of a plurality of types of sounds including steady sound indicating that the user's hand has been recognized by the camera and sound that changes in accordance with a change in the distance between the user's hand and the virtual object.

Furthermore, as well as the change in the distance, the information processing device 100 may output some kind of sound by triggering that, for example, the controller has been operated or the user's hand has touched the virtual object. Furthermore, the information processing device 100 may output sound with relatively bright tone in the case of having recognized the user's hand, and may output sound with relatively dark tone in a case where the user's hand is likely to move out from the angle of view of the camera. With this arrangement, the information processing device 100 can perform feedback with sound even for an interaction visually unrecognizable on an AR space, so that recognition by the user can be improved.

Furthermore, the information processing device 100 may feedback information related to the motion of the first object, with an output signal. For example, the information processing device 100 may output sound that continuously changes in accordance with the velocity or acceleration of the motion of the user's hand. For example, the information processing device 100 may output louder sound as the velocity of the motion of the user's hand increases.

In each of the above embodiments, there has been exemplified that the information processing device 100 determines the state of the user for each frame. The information processing device 100, however, does not necessarily determine the states of all the frames. For example, the information processing device 100 may smooth several frames and may determine the states every several frames.

Furthermore, the information processing device 100 may use not only the camera but also various types of sensing information for recognizing the first object. For example, in a case where the first object is the controller CR01, the information processing device 100 may recognize the position of the controller CR01 on the basis of the velocity or acceleration measured by the controller CR01, information related to the magnetic field generated by the controller CR01, or the like.

Furthermore, the second object is not necessarily limited to a virtual object, and may be some kind of point on the real space that the user's hand should reach. For example, the second object may be a selection button indicating intention of the user (e.g., a virtual button with which “yes” or “no” is indicated) displayed on an AR space. Still furthermore, the second object is not necessarily recognized visually by the user via the display unit 61. That is, the display mode of the second object may be any mode if some kind of information related the coordinates to be reached by the user's hand is given.

Furthermore, the information processing device 100 may give a directionality to output sound or output vibration. For example, in the case of having already recognized the position of the user's hand, the information processing device 100 may apply a technique related to stereophonic sound and may give a pseudo-directionality such that the user perceives that sound is output from the position of the user's hand. Furthermore, in a case where the holding part 70 corresponding to the eyeglass frame has a vibration function, the information processing device 100 may give a directionality to output related to vibration, such as vibrating part of the holding part 70 closer to the user's hand.

Furthermore, of the pieces of processing described in each of the above embodiments, the entirety or part of the processing that has been described as being automatically performed can be performed manually, or the entirety or part of the processing that has been described as being performed manually can be performed automatically with a known method. In addition to the above, the processing procedures, specific names, information including various types of data and parameters illustrated in the above descriptions and drawings can be freely changed unless otherwise specified. For example, the various types of information illustrated in each drawing are not limited to the illustrated information.

Furthermore, each constituent element of the devices illustrated in the drawings is functionally conceptual, and thus is not necessarily configured physically as illustrated. That is, the specific mode of separation or integration of each device is not limited to that illustrated in the drawings, and thus the entirety or part of the devices can be functionally or physically separated or integrated on a unit basis in accordance with various types of loads or usage situations. For example, the recognition unit 31 and the acquisition unit 32 illustrated in FIG. 3 may be integrated.

Furthermore, each of the above embodiments and modifications can be appropriately combined within the range in which the processing content is not inconsistent.

Furthermore, the effects described herein are merely examples and are not limited, and thus there may be additional effects.

### 6. Hardware Configuration

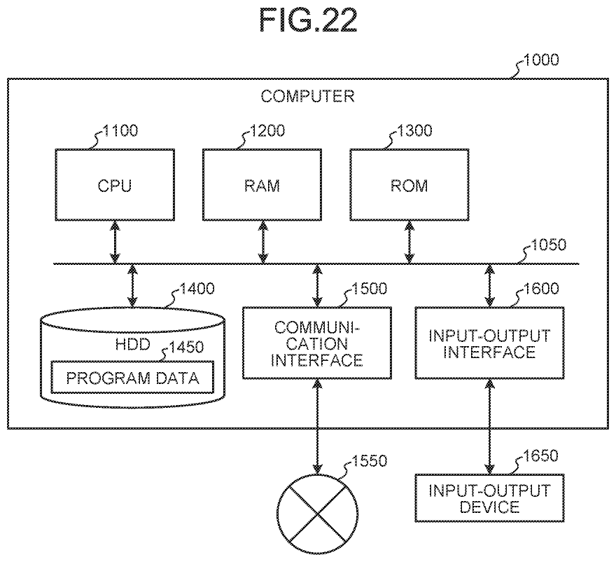

The information devices such as the information processing device, the wristband, and the controller according to each of the above embodiments are achieved by, for example, a computer 1000 having such a configuration as illustrated in FIG. 22. Hereinafter, the information processing device 100 according to the first embodiment will be described as an example. FIG. 22 is a hardware configuration diagram of an example of the computer 1000 that achieves the functions of the information processing device 100. The computer 1000 includes a CPU 1100, a RAM 1200, a read only memory (ROM) 1300, a hard disk drive (HDD) 1400, a communication interface 1500, and input-output interface 1600. Each constituent of the computer 1000 is connected by a bus 1050.

The CPU 1100 operates in accordance with a program stored in the ROM 1300 or the HDD 1400, and controls each constituent. For example, the CPU 1100 expands the program stored in the ROM 1300 or the HDD 1400 into the RAM 1200, and executes processing in accordance with the corresponding program.

The ROM 1300 stores a boot program such as a basic input output system (BIOS) executed by the CPU 1100 on startup of the computer 1000, a program dependent on the hardware of the computer 1000, and the like.

The HDD 1400 is a computer-readable recording medium that non-temporarily stores a program executed by the CPU 1100, data used by the program, and the like. Specifically, the HDD 1400 is a recording medium that stores the information processing program according to the present disclosure that is an example of program data 1450.

The communication interface 1500 is an interface for connecting the computer 1000 and an external network 1550 (e.g., the Internet). For example, the CPU 1100 receives data from another device or transmits data generated by the CPU 1100 to the other device via the communication interface 1500.

The input-output interface 1600 is an interface for connecting an input-output device 1650 and the computer 1000. For example, the CPU 1100 receives data from an input device such as a keyboard or a mouse via the input-output interface 1600. Furthermore, the CPU 1100 also transmits data to an output device such as a display, a speaker, or a printer via the input-output interface 1600. Furthermore, the input-output interface 1600 may function as a media interface that reads a program or the like stored in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in the case where the computer 1000 functions as the information processing device 100 according to the first embodiment, the CPU 1100 of the computer 1000 executes the information processing program loaded on the RAM 1200 to realize the function of, for example, the recognition unit 31. In addition, the HDD 1400 stores the information processing program according to the present disclosure and data in the storage unit 50. Note that the CPU 1100 reads the program data 1450 from the HDD 1400 and executes the program data 1450; however, as another example, these programs may be acquired from another device via the external network 1550.

Note that the present technology can also adopt the following configurations.

(1)

An information processing device, comprising:

an acquisition unit configured to acquire a change in a distance between a first object operated by a user on a real space and a second object displayed on a display unit; and

an output control unit configured to perform first control such that vibration output from a vibration output device is continuously changed based on the acquired change in the distance.

(2)

The information processing device according to (1),

wherein the acquisition unit

acquires the change in the distance between the second object displayed on the display unit as a virtual object superimposed on the real space, and the first object.

(3)

The information processing device according to (2),

wherein the acquisition unit

acquires the change in the distance between the first object detected by a sensor and the second object displayed on the display unit as the virtual object.

(4)

The information processing device according to any one of (1) to (3),

wherein the output control unit

stops the first control when the distance between the first object and the second object reaches a predetermined threshold or less.

(5)

The information processing device according to any one of (1) to (4),

wherein, in the first control, the output control unit

controls the vibration output device such that the vibration output device outputs sound in accordance with the acquired change in the distance.

(6)

The information processing device according to (5),

wherein based on the acquired change in the distance, the output control unit

continuously changes at least one of volume, cycle, or frequency of the sound output from the vibration output device.

(7)

The information processing device according to any one of (1) to (6),

wherein the acquisition unit

acquires position information indicating a position of the first object, with a sensor having a detection range wider than an angle of view of the display unit as viewed from the user, and

the output control unit

performs second control such that the vibration output is changed based on the acquired position information.

(8)

The information processing device according to (7),

wherein as the second control, the output control unit

continuously changes the vibration output in accordance with approach of the first object to a boundary of the detection range of the sensor.

(9)

The information processing device according to (8),

wherein the output control unit

makes the vibration output vary between a case where the first object approaches the boundary of the detection range of the sensor from outside the angle of view of the display unit and a case where the first object approaches the boundary of the detection range of the sensor from inside the angle of view of the display unit.

(10)

The information processing device according to any one of (7) to (9),

wherein the acquisition unit

acquires position information of the second object on the display unit, and

the output control unit

changes the vibration output in accordance with approach of the second object from inside the angle of view of the display unit to a vicinity of a boundary between inside and outside the angle of view of the display unit.

(11)

The information processing device according to any one of (7) to (10),

wherein the acquisition unit

acquires information indicating that the first object has transitioned from a state where the first object is undetectable by the sensor to a state where the first object is detectable by the sensor, and

the output control unit

changes the vibration output in a case where the information indicating that the first object has transitioned to the state where the first object is detectable by the sensor is acquired.

(12)

The information processing device according to any one of (1) to (11),

wherein the acquisition unit

acquires a change in a distance between the second object and a hand of the user detected by a sensor or a controller that the user operates, detected by the sensor.

(13)

The information processing device according to any one of (1) to (12), further comprising:

the display unit having transparency, the display unit being held in a direction of line-of-sight of the user.

(14)

An information processing method, by a computer, comprising:

acquiring a change in a distance between a first object operated by a user on a real space and a second object displayed on a display unit; and

performing first control such that vibration output from a vibration output device is continuously changed based on the acquired change in the distance.

(15)

A non-transitory computer-readable recording medium storing an information processing program for causing a computer to function as:

an acquisition unit configured to acquire a change in a distance between a first object operated by a user on a real space and a second object displayed on a display unit; and

an output control unit configured to perform first control such that vibration output from a vibration output device is continuously changed based on the acquired change in the distance.

### REFERENCE SIGNS LIST

1, 2, 3, 4 INFORMATION PROCESSING SYSTEM
100, 100a, 100b INFORMATION PROCESSING DEVICE
20 SENSOR
30 CONTROL UNIT
31 RECOGNITION UNIT
32 ACQUISITION UNIT
33 OUTPUT CONTROL UNIT
50, 50A STORAGE UNIT
51, 51A OUTPUT DEFINITION DATA
60 OUTPUT UNIT
61 DISPLAY UNIT
62 ACOUSTIC OUTPUT UNIT
63 VIBRATION OUTPUT UNIT
80 WRISTBAND
CR01 CONTROLLER

1. An information processing device, comprising:
an acquisition unit configured to acquire a change in a distance between a first object operated by a user on a real space and a second object displayed on a display unit; and
an output control unit configured to perform first control such that vibration output from a vibration output device is continuously changed based on the acquired change in the distance.

2. The information processing device according to claim 1,
wherein the acquisition unit
acquires the change in the distance between the second object displayed on the display unit as a virtual object superimposed on the real space, and the first object.

3. The information processing device according to claim 2,
wherein the acquisition unit
acquires the change in the distance between the first object detected by a sensor and the second object displayed on the display unit as the virtual object.

4. The information processing device according to claim 1,
wherein the output control unit
stops the first control when the distance between the first object and the second object reaches a predetermined threshold or less.

5. The information processing device according to claim 1,
wherein, in the first control, the output control unit
controls the vibration output device such that the vibration output device outputs sound in accordance with the acquired change in the distance.

6. The information processing device according to claim 5,
wherein based on the acquired change in the distance, the output control unit
continuously changes at least one of volume, cycle, or frequency of the sound output from the vibration output device.

7. The information processing device according to claim 1,
wherein the acquisition unit
acquires position information indicating a position of the first object, with a sensor having a detection range wider than an angle of view of the display unit as viewed from the user, and
the output control unit
performs second control such that the vibration output is changed based on the acquired position information.

8. The information processing device according to claim 7,
wherein as the second control, the output control unit
continuously changes the vibration output in accordance with approach of the first object to a boundary of the detection range of the sensor.

9. The information processing device according to claim 8,
wherein the output control unit
makes the vibration output vary between a case where the first object approaches the boundary of the detection range of the sensor from outside the angle of view of the display unit and a case where the first object approaches the boundary of the detection range of the sensor from inside the angle of view of the display unit.

10. The information processing device according to claim 7,
wherein the acquisition unit
acquires position information of the second object on the display unit, and
the output control unit
changes the vibration output in accordance with approach of the second object from inside the angle of view of the display unit to a vicinity of a boundary between inside and outside the angle of view of the display unit.

11. The information processing device according to claim 7,
wherein the acquisition unit
acquires information indicating that the first object has transitioned from a state where the first object is undetectable by the sensor to a state where the first object is detectable by the sensor, and
the output control unit
changes the vibration output in a case where the information indicating that the first object has transitioned to the state where the first object is detectable by the sensor is acquired.

12. The information processing device according to claim 1,
wherein the acquisition unit p1 acquires a change in a distance between the second object and a hand of the user detected by a sensor or a controller that the user operates, detected by the sensor.

13. The information processing device according to claim 1, further comprising:
the display unit having transparency, the display unit being held in a direction of line-of-sight of the user.

14. An information processing method, by a computer, comprising:
acquiring a change in a distance between a first object operated by a user on a real space and a second object displayed on a display unit; and
performing first control such that vibration output from a vibration output device is continuously changed based on the acquired change in the distance.

15. A non-transitory computer-readable recording medium storing an information processing program for causing a computer to function as:
an acquisition unit configured to acquire a change in a distance between a first object operated by a user on a real space and a second object displayed on a display unit; and
an output control unit configured to perform first control such that vibration output from a vibration output device is continuously changed based on the acquired change in the distance.
